(19) United States
(12) Patent Application Publication
(10) Pub. No.: US 2023/0064810 A1
(43) Pub. Date: Mar. 2, 2023

(54) ELECTRIC RAT KILLER

(71) Applicant: Shenzhen Palaza Technology Co., ltd., Shenzhen (CN)

(72) Inventor: Wenjin Feng, Guangdong Province (CN)

(21) Appl. No.: 17/458,587

(22) Filed: Aug. 27, 2021

(51) Int. Cl. A01M 23/38; A01M 23/16; A01M 19/00

(52) U.S. Cl. CPC A01M 23/38; A01M 23/16; A01M 19/00; A01M 2200/00

(57) ABSTRACT

The present invention discloses an electric rat, killer, wherein a box body is of a hollow box body structure, the box body is provided with unidirectional doors on two sides, an infrared sensor inside, a bottom plate at the bottom and a top plate at the top, and the box body fixes the top plate and the bottom plate through buckling pieces; and a high-voltage module is arranged in the top plate, the infrared sensor detects a rat entering signal and transmits the signal to the high-voltage module to perform electric shock action, and a control key can be pressed to kill a rat by a manual electric shock mode. According to the present invention, the unidirectional doors are arranged on the two sides of the box body, thereby preventing a rat from escaping after entering the box body; the infrared sensor, a circuit board and an electrified net are provided for cooperation at the same time to kill a rat through electric shock, so that energy conservation and higher efficiency are achieved; and the box body fixes the bottom plate and the top plate through the buckling pieces, thereby facilitating disassembling and rat cleaning. Therefore, the present invention has the characteristic of energy conservation, capability of trapping rats continuously and higher efficiency.

### TECHNICAL FIELD

The present invention relates to the technical field of articles for daily use, and more particularly, to an electric rat killer.

### BACKGROUND

Rats steal food and spread diseases, which are extremely fertile and harmful to human beings. Therefore, deratization is a long-term task facing all mankind. There are numerous types of rat traps used by people at present including a rattrap, a rat-trap, a box type rat trap, a photoelectric rat trap and rat glue. There are many types of rat traps, some of which can continuously trap rats, but the rat trap circuit consumes a large amount of electric energy and has high rat trap cost, which is unfavorable for saving energy. The rat trap includes a box body with a forward opening, a door placing port is formed in an upper surface of the front of the box body, a front door is placed in the door placing port, and an upper surface of the front door is tied with a pull rope. During use, it is necessary to take away the front door and, place food in the box body, a rat will go in the box body to eat food. At this time, the front door is taken down, and the rat is trapped. The rat trap wastes manpower and has poor use effect. Moreover, the traditional rat-trap only can trap rats, and how to deal with the trapped rats is a thorny problem.

Therefore, how to provide a rat trap which has good rat trap effect and low cost and can continuously trap and kill rats is an urgent problem for those skilled in the art.

### SUMMARY

In view of this, the present invention provides an electric rat killer, which has good rat trap effect and low cost and can continuously trap and kill rats.

In order to achieve the above objective, the present invention provides the following technical solution: an electric rat killer includes: a box body and a high-voltage module, wherein the box body is of a hollow box body structure, and the box body is provided with unidirectional doors on two sides, a bottom plate at the bottom and a top plate at the top; and the high-voltage module is arranged in the top plate.

Preferably, in the electric rat killer, the high-voltage module includes: a circuit board, an electrified net, a storage battery, a start switch and a charging interface, wherein the circuit board is provided with a connecting piece and electrically connected to the charging interface, the storage battery and the start switch, the start switch and the charging interface are arranged on two sides of the top plate, and the connecting piece is connected to the electrified net.

Preferably, in the electric rat killer, the top plate is further provided with several buckling grooves.

Preferably, in the electric rat killer, the box body is internally provided with several buckling pieces; and two ends of each of the buckling pieces are fixed to the buckling grooves in fixing plates of the bottom plate and the top plate respectively.

Preferably, in the electric rat killer, the electrified net is arranged in the bottom plate.

Preferably, in the electric rat killer, the circuit plate is further provided with a status indicating lamp.

Preferably, in the electric rat killer, rotating shaft pieces are arranged on two sides of the box body, and the unidirectional doors are fixed at the box body through the rotating shaft pieces.

Preferably, in the electric rat killer, the fixing plate is further provided with several buckling grooves and is fixed on the top plate through a screw.

Preferably, in the electric rat killer, a limiting plate is arranged at the box body and the unidirectional doors, an infrared sensor is arranged on the box body, and the infrared sensor, is in signal connection to a signal processing circuit of the circuit board.

Preferably, in the electric rat killer, a controller, a charging management circuit, a boost control circuit and an output circuit are arranged on the circuit board, the controller is in electrical signal connection to the control key and the infrared sensor, and the controller outputs high-voltage current through the boost control circuit and the output circuit for charging the battery through charging management current.

According to the above technical solution, compared with the prior art, the present invention provides an electric rat killer, wherein the unidirectional doors are arranged on the two sides of the box body and the box body is provided with the limiting plate, thereby preventing a rat from escaping after entering the box body; the infrared sensor, the circuit board and the electrified net are provided for cooperation with the manually controlled control key at the same time to kill a rat through manual and automatic electric shock, so that energy conservation and higher efficiency are achieved; and the box body fixes the bottom plate and the top plate through the buckling pieces, thereby facilitating disassembling and rat cleaning. Therefore, the present invention has the characteristic of energy conservation, capability of trapping and killing rats continuously and higher efficiency.

### DESCRIPTION OF THE DRAWINGS

To describe the technical solutions in the embodiments of the present invention or in the prior art more clearly, the following briefly describes the accompanying drawings required for describing the examples or the prior art. Apparently, the accompanying drawings in the following description are only the embodiments of the present invention, and a person of ordinary skill in the art may still derive other drawings from these accompanying drawings without creative efforts.

FIG. 1 is a schematic diagram of a three-dimensional structure according to the present invention.

FIG. 2 is a schematic diagram of a sectional structure according to the present invention.

FIG. 3 is a schematic diagram of a structure of a top plate according to the present invention.

FIG. 4 is a schematic diagram of an internal structure of a top plate according to the present invention.

FIG. 5 is a schematic diagram of an internal structure of a bottom plate according to the present invention.

FIG. 6 is a schematic diagram of a working principle of a circuit board according to the present invention.

### DETAILED DESCRIPTION OF EMBODIMENTS

The following clearly and completely describes the technical solutions in the embodiments of the present invention with reference to accompanying drawings in the embodiments of the present invention. Apparently, the described embodiments are merely a part rather than all of the embodiments of the present invention. Based on the embodiments in the present invention, all other embodiments obtained by those skilled in the art without creative efforts shall fall within the protection scope of the present invention.

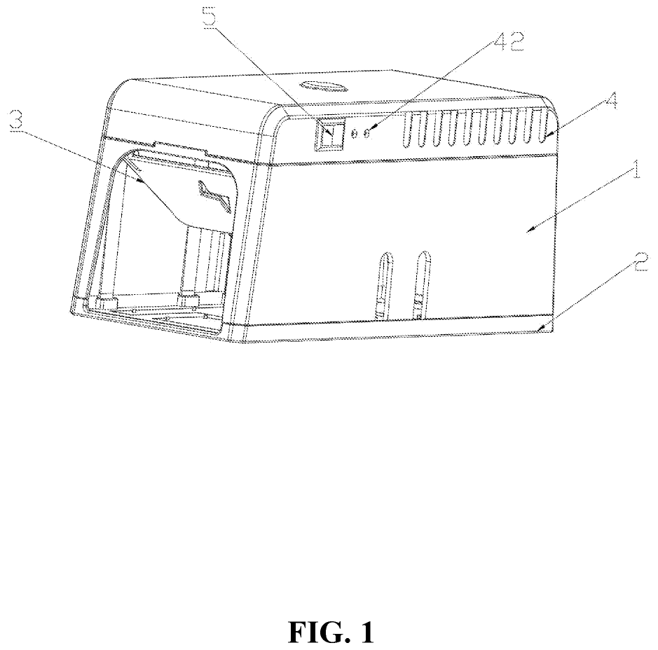

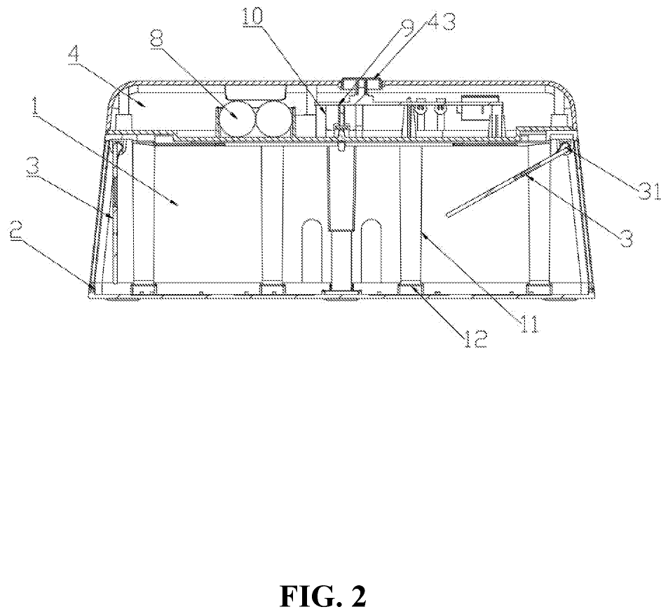

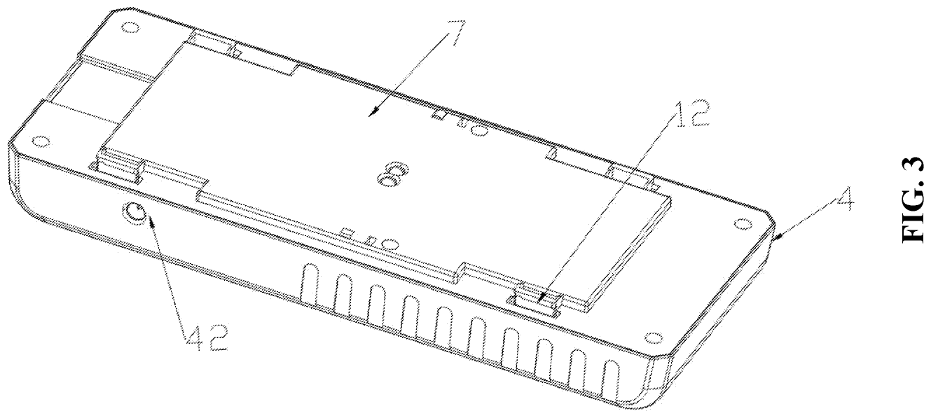

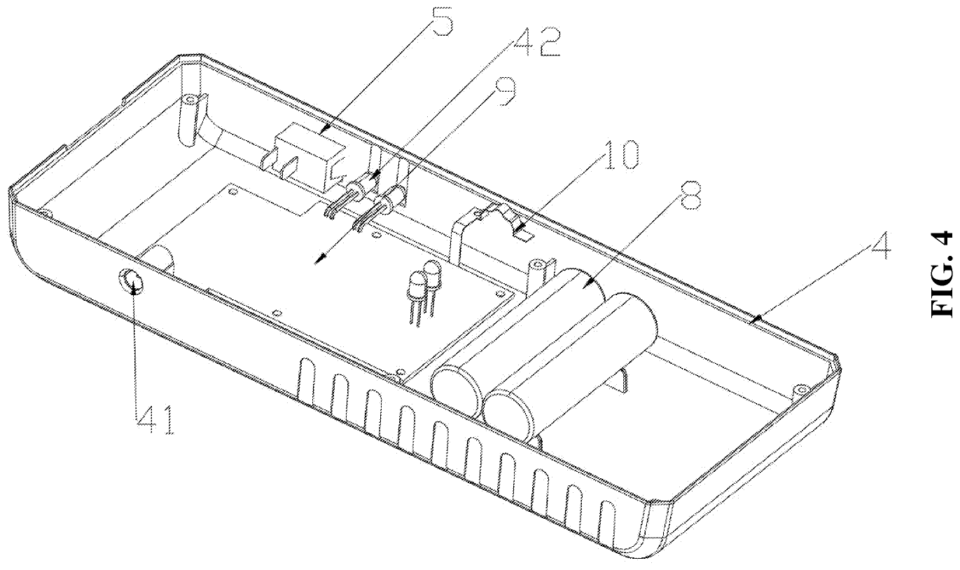

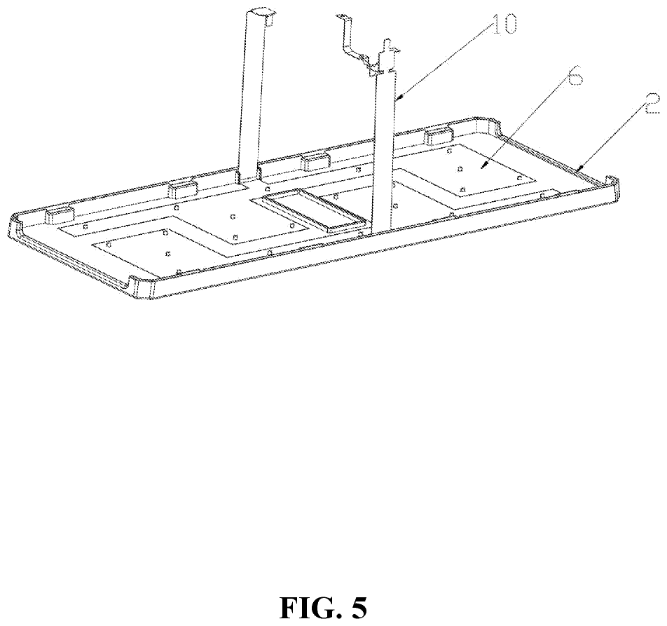

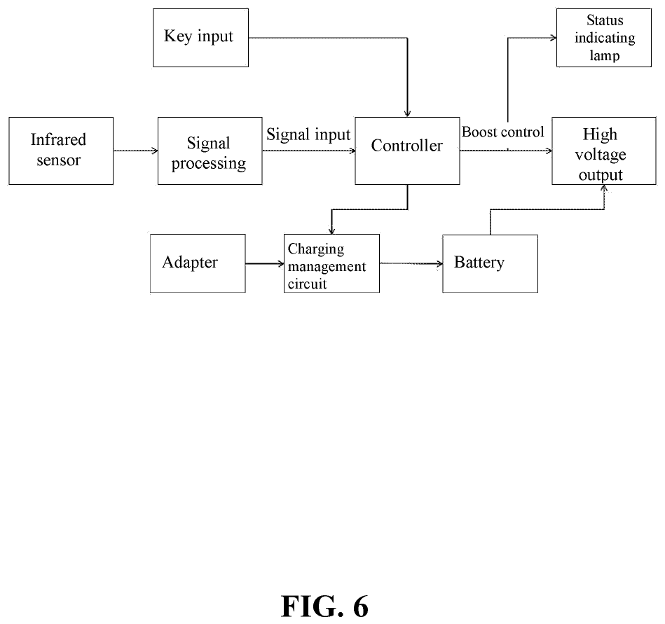

Referring to FIG. 1 to FIG. 6, the present invention discloses an electric rat killer.

According to the present invention, the electric rat killer includes: a box body 1 and a high-voltage module, wherein the box body 1 is of a hollow box body structure, and the box body 1 is provided with unidirectional doors 3 on two sides, a bottom plate 2 at the bottom and a top plate 3 at the top; the high-voltage module is arranged in the top plate 4 and includes: a circuit board 9, an electrified net 6, a storage battery 8, a start switch 5 and a charging interface 41; the circuit board 9 and the charging interface 41, and the storage 8 and the start switch 5 are electrically connected; the start switch 5 and the charging interface 41 are arranged on two sides of the top plate 4; the connecting piece 10 is connected to the electrified net 6; the top plate 4 is further provided with several buckling grooves 12; the box body is internal provided with several buckling pieces 11; two ends of each of the buckling pieces 11 are fixed to the buckling grooves 12 of the top plate 4 and the fixing plate 7 respectively; the electrified net 6 is arranged on the bottom plate 2; the circuit board 9 is further provided with a status indicating lamp 42; rotating shaft pieces 31 are arranged on two sides of the box body 1; the unidirectional doors 3 are fixed at the box body 1 through the rotating shaft pieces 31; the fixing plate 7 is further provided with several buckling grooves 12; the fixing plate 7 is fixed on the top plate 4 through a screw; a limiting plate is arranged at the box body 1 and the unidirectional doors 3; an infrared sensor is arranged on the box body; the infrared sensor is in signal connection with a signal processing circuit of the circuit board; the circuit board is provided with a controller, a charging management circuit, a boost control circuit and an output circuit; the controller is in electrical signal connection with the control key 43 and the infrared sensor; and the controller outputs high-voltage current through the boost control circuit and the output circuit for charging the battery through charging management current.

In order to further optimize the above technical solution, during use, after the parts are mounted according to the above relation, the start switch 5 is started. When rats enter the box body 1 through the unidirectional doors 3, the infrared sensor detects that the rats enter and transmits an instruction signal to the circuit board 9. At this time, the circuit board 9 supplies power to the electrified net 6 through the connecting piece 10. The rats are knocked down by the high voltage of the electrified net 6, so that the rats are continuously trapped and killed. After the rats are trapped, the box body 1 is opened up and down through the buckling piece 11 of the box body 1, so that the trapped rats are poured out and cleaned. When there are too many rats in the box body and not all of them are killed, the electrified net 6 is controlled through the control key 43 of the top plate for manually controlling electric shock. After the infrared sensor detects that rats enter the cabin, the electric shock function is started, electric shock adopts a periodical discharge mode, the rats suffer from convulsion and anoxia under the periodic high-voltage impact, and the rats are finally killed. Therefore, the efficiency of electrically killing the rats can be improved, electricity consumption and heat generation of chips and the high-voltage circuit can be reduced, the circuit safety is protected to avoid false triggering, and the electric rat killer keeps discharging to result in that the battery is exhausted.

In order to further optimize the above technical solution, during use, the status indicating lamp 42 is used to indicate a working status and an electric quantity status of the battery 8. When the battery 8 is dead, the storage battery 8 is charged by the charging interface 41.

In order to further optimize the above technical solution, the boost control circuit in the circuit board forms an oscillating voltage doubling circuit through a high-voltage coil, a diode and a high-voltage capacitor and increases the voltage to a high voltage of 4000-5000V; the controller controls the oscillating circuit to work through an MOS tube; and the signal processing circuit adjusts the flexibility and the detection distance of the infrared sensor, so that the best detection effect is achieved, and error detection caused by weak signal jitter is avoided.

Each embodiment of the present specification is described in a progressive manner, each embodiment focuses on the difference from other embodiments, and the same and similar parts between the embodiments may refer to each other. For a device disclosed in the embodiments, since it corresponds to the method disclosed in the embodiments, the description is relatively simple, and reference can be made to the method description.

The above description of the disclosed embodiments enables a person skilled in the art to implement or use the present invention. Various modifications to these embodiments are readily apparent to a person skilled in the art, and the generic principles defined herein may be implemented in other embodiments without departing from the spirit or scope of the present invention. Thus, the present invention is not limited to the embodiments shown herein but falls within the widest scope consistent with the principles and novel features disclosed herein.

1. An electric rat killer, comprising: a box body and a high-voltage module, wherein the box body is of a hollow box body structure, and the box body is provided with unidirectional doors on two sides, a bottom plate at the bottom and a top plate at the top; and the high-voltage module is arranged in the top plate.

2. The electric rat killer according to claim 1, wherein the high-voltage module comprises: a circuit board an electrified net, a storage battery, a start switch and a charging interface, the circuit board being provided with a connecting piece and electrically connected to the charging interface, the storage battery and the start switch, the start switch and the charging interface being arranged on two sides of the top plate, and the connecting piece being connected to the electrified net.

3. The electric rat killer according to claim 1, wherein the top plate is provided with a control key and several buckling grooves.

4. The electric rat killer according to claim 1, wherein the box body is internally provided with several buckling pieces; and two ends of each of the buckling pieces are fixed to the buckling grooves in fixing plates of the bottom plate and the top plate respectively.

5. The electric rat killer according to claim 2, wherein the electrified net is arranged in the bottom plate.

6. The electric rat killer according to claim 2, wherein the circuit board is further provided with a status indicating lamp.

7. The electric rat killer according to claim 4, wherein rotating shaft pieces are arranged on two sides of the box body, and the unidirectional doors are fixed at the box body through the rotating shaft pieces.

8. The electric rat killer according to claim 5, wherein the fixing plate is further provided with several buckling grooves and is fixed on the top plate through a screw.

9. The electric rat killer according to claim 7, wherein a limiting plate is arranged at the box body and the unidirectional doors, an infrared sensor is arranged on the box body, and the infrared sensor is in signal connection to a signal processing circuit of the circuit board.

10. The electric rat killer according to claim 7, wherein a controller, a charging management circuit, a boost control circuit and an output circuit are arranged on the circuit board, the controller is in electrical signal connection to the control key and the infrared sensor, and the controller outputs high-voltage current through the boost control circuit and the output circuit for charging the battery through charging management current.
